(19) United States
(12) Patent Application Publication
(10) Pub. No.: US 2008/0297367 A1
(43) Pub. Date: Dec. 4, 2008

(54) MULTI-PURPOSE PORTABLE ALARM

(76) Inventor: Mike Chen, Irvine, CA (US)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/755,545

(22) Filed: May 30, 2007

(51) Int. Cl. G08B 21/00

(52) U.S. Cl. 340/687

(57) ABSTRACT

A multi-purpose portable alarm including an alarm unit attached with a ring hook provided with an opening; a wider long side inserted with a sleeve and a narrower short side having its free end to be locked by the sleeve being disposed on both sides of the opening, a locking sleeve being inserted onto the long side to block up the opening for the hook to hook upon a connecting component to secure the hook thus the alarm to an object to be protected for the alarm to generate audible alarm once the alarm unit detects abnormal tilting or vibration.

### BACKGROUND OF THE INVENTION

(a) Field of the Invention

The present invention is related to a multi-purpose portable alarm, and more particularly, to one that prevents from easy breaking away from an object attached to and protected by the alarm.

(b) Description of the Prior Art

There are many structural types found with portable alarms generally available in the market. A common type of structure works with a pin to engage an alarm to an object, e.g., a purse, a cellular phone or any other small electronic product, to be protected from a burglar. The pin is further connected by means of a cord to an external portion of the object. Whenever the burglar is attempting to steal away the object, the pin will be pulled and disengaged from the alarm to trigger off audible alarm to deter the burglar from stealing the object.

Another type of the portable alarm works with a locking ring (hook) attached to a larger object, e.g., a luggage, to be protected from the burglar. Whereas this type of alarm is very sensitive to vibration (shock), any vibration (shock) created when the burglar attempts to move the object by the burglar will trigger off audible alarm to warn off the burglar.

However, the application of the prior art is limited. Either of the alarm of the prior art described above is designed exclusively for a given purpose thus prevents it from having easy attachment to other objects for delivering different value-added function. For convenient operation of the alarm, the locking ring (hook) is designed with a structure that allows easy attachment or detachment to or from the object to be protected, making it easy also for the burglar to remove the alarm from the object in a very short time to render the alarm useless.

### SUMMARY OF THE INVENTION

The primary purpose of the present invention is to provide a multi-purpose portable alarm to provide wider range of application and higher added value by creating new functions with various types of connecting components.

Another purpose of the present invention is to provide a multi-purpose portable alarm designed with a special hook to prevent it from easy parting away from the connecting component thus to give better burglarproof effects.

To achieve these purposes, a multi-purpose portable alarm of the present invention includes an alarm unit capable of detecting abnormal tilting and vibration to trigger off audible alarm; and a hook incorporated to the alarm unit and provided with a ring having an opening, a wider long side and a narrower short side are respectively disposed to both sides of the opening of the hook, a screw sleeve inserted onto the long side, a free end of the short side to be engaged by the screw sleeve to block up the opening for the hook to be easily hooked upon a connecting component attached to an object to be protected to further secure the alarm to a preset location on the object.

### BRIEF DESCRIPTION OF THE DRAWINGS

FIG. 1 is an exploded view showing a basic construction of the present invention.

FIG. 2 is a perspective view of the present invention.

FIG. 3 is a view showing a first a preferred embodiment of the present invention.

FIG. 4 is a view showing a second preferred embodiment of the present invention.

FIG. 5 is an exploded view showing a third preferred embodiment yet of the present invention.

FIG. 6 is a schematic view showing a partially assembled of the third preferred embodiment of the present invention.

FIG. 7 is a schematic view showing an operating status of the third preferred embodiment of the present invention.

FIG. 8 is a schematic view showing another operating status of the third preferred embodiment of the present invention.

### DETAILED DESCRIPTION OF THE PREFERRED EMBODIMENTS

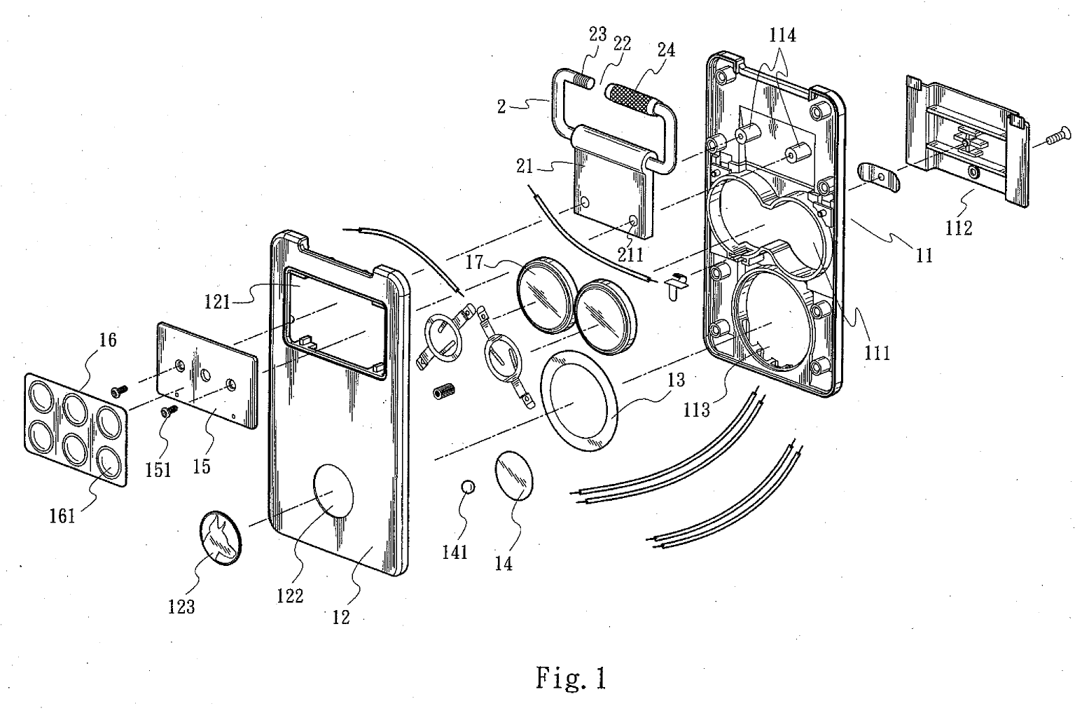

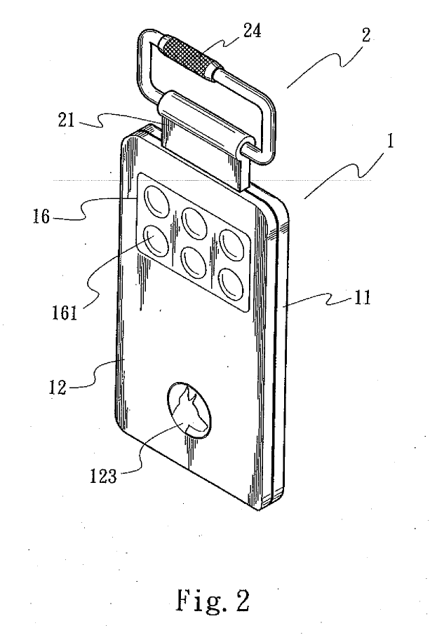

Referring to FIGS. 1 and 2, a multi-purpose portable alarm of the present invention includes an alarm unit 1 and a hook. The alarm unit 1 is comprised of a base seat 11 and a cover 12 closing upon each other to form a housing. A hollowed battery chamber 111 to accommodate multiple, and two as illustrated, batteries 17, and a battery cover 112 to close the battery chamber 111 is disposed on a back of the battery chamber 111. An accommodation chamber 113 to receive a buzzer 13 and multiple locating screw holes 114 are respectively disposed on both sides of the battery chamber 11 on the base seat 11. A first hollowed portion 121 corresponding to those locating screw holes 114 is provided on the cover 12 to merely receive a circuit board 15 and secure it by fastening multiple locating bolts 151 into their respective locating holes 114 on the base seat 11. A plate press key module 16 provided with multiple film keys 161 covers upon a surface of the cover 12. A second hollowed portion 122 opposite to the first hollowed portion 121 is disposed on the cover 12 to receive a vibration switch 14 containing a ball 141. An ornamental piece 123 may cover up an outer surface of the second hollowed portion 122. The vibration switch 14 detects abnormal tilting and vibration as the ball 141 rolls to drive the buzzer 13 through the circuit board 15 to generate audible alarm. Those multiple film keys 161 disposed on the press key module 16 control multiple functions of the alarm unit 1. The hook 2 is pivoted to a base 21. Multiple locating holes 211 are disposed on a peripheral of the base 21 and the base 21 of the hook 2 is secured to those locating screw holes 114 provided on the base seat 11 using those same locating bolts 151. The hook 2 indicates a shape of a rectangular ring provided with an opening 22. A long side and a short side are respectively provided to both sides of the opening 22 for the hook 2 to be inserted into corresponding holes from a belt or a locking ring to prevent the hook 2 from being easily removed or released. A screw sleeve 24 (or alternatively a long nut) is inserted onto a free end of the long side of the hook 2 and a free end 23 of the short side of the hook 2 (or alternatively a free end externally threaded) to engage the screw sleeve 24 (may be internally threaded) to block up the opening 22 for locking purpose.

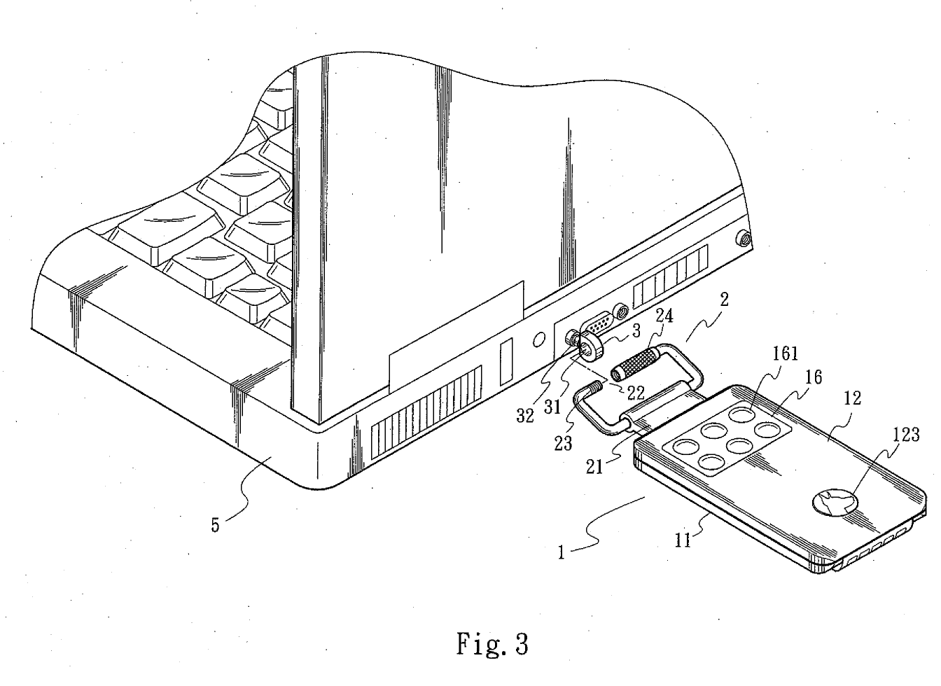

Now referring to FIG. 3 for a first preferred embodiment of the present invention, the hook 2 locks into a through hole 31 at one end of a locking member 3. A bolting portion 32 is disposed on the other end of the locking member 3 to be secured into a fixing screw hole 521 provided on one side of an image (e.g., a display card) output port 52. An audible alarm is generated whenever the alarm unit 1 detects abnormal tiling and vibration to achieve the basic burglarproof purpose.

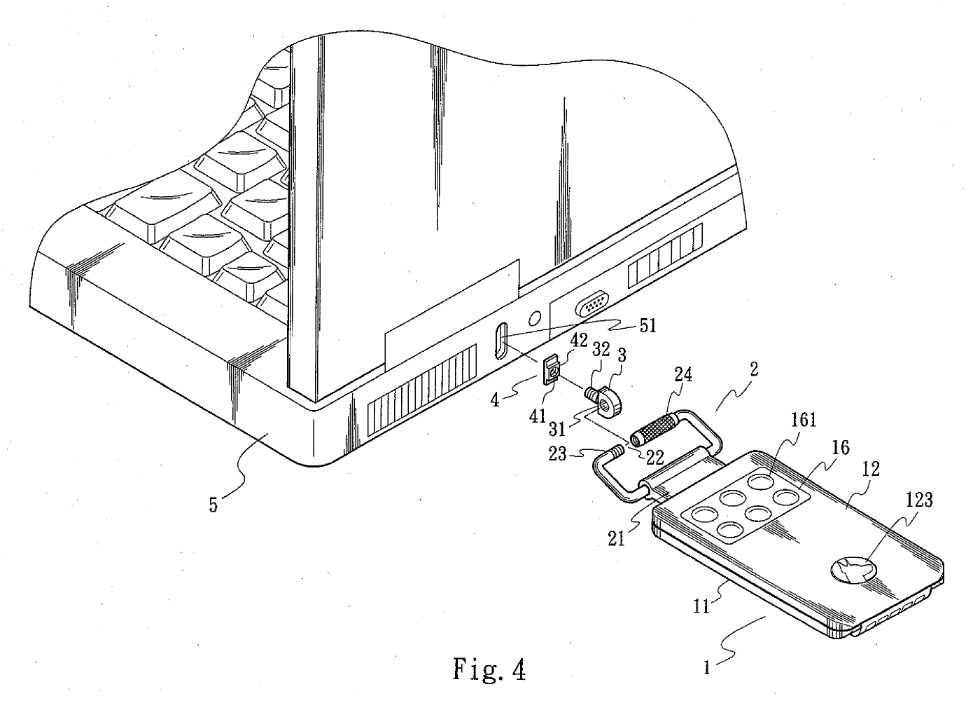

In a second preferred embodiment according to the first preferred embodiment of the present invention as illustrated in FIG. 4, the hook 2 is engaged with the locking member 3; the bolting portion 32 of the locking member 3 is screwed into a central screw hole 41 disposed at a retainer 4; the retainer 4 is then extends into a rectangular locking hole 51 disposed on one edge of a portable object 5 (e.g., a Notebook). The retainer 4 upon entering into the locking hole 51 is deflected before tightening up the locking member 3 so that the retainer 4 is outwardly packed and secured on the inner side of the locking hole 51; meanwhile, a raised portion 42 disposed on a front of the retainer 4 is merely restricted in the locking hole 51 to prevent the retainer 4 from rotating. Accordingly, the alarm unit 1 is connected to the portable object 5 through the hook 2 and the locking member 3.

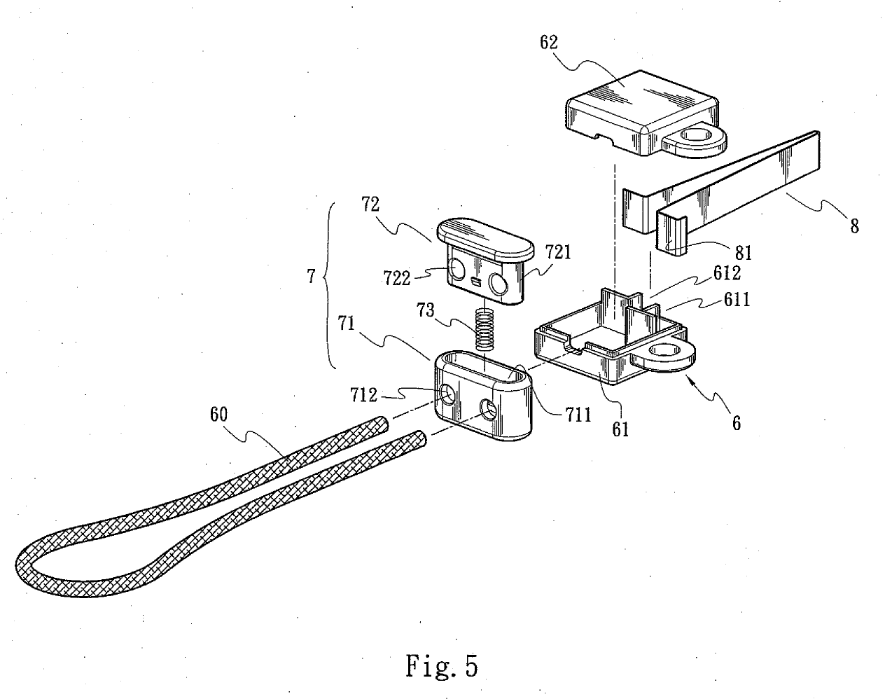

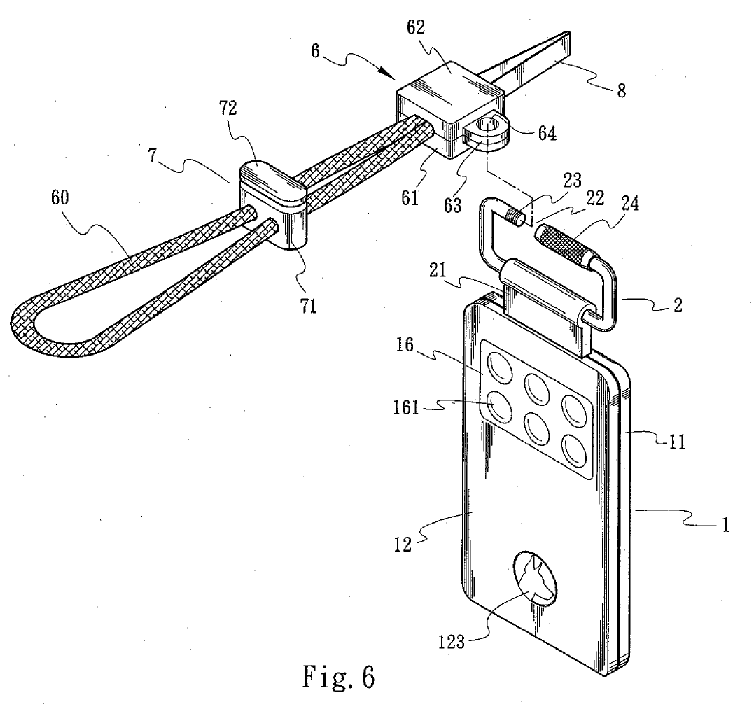

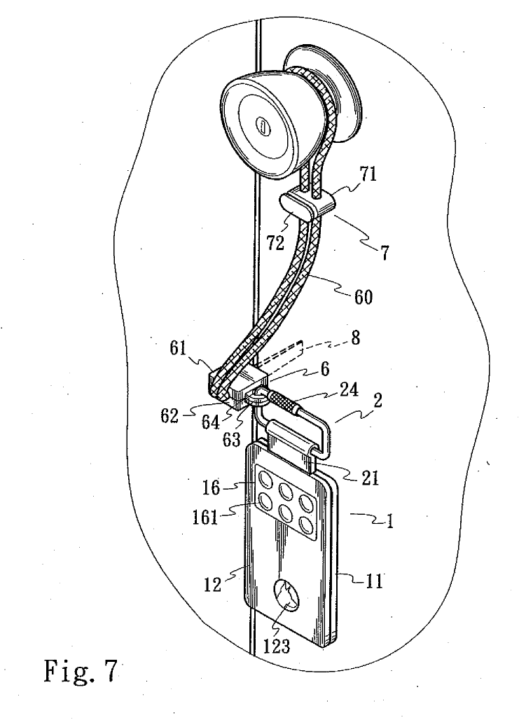

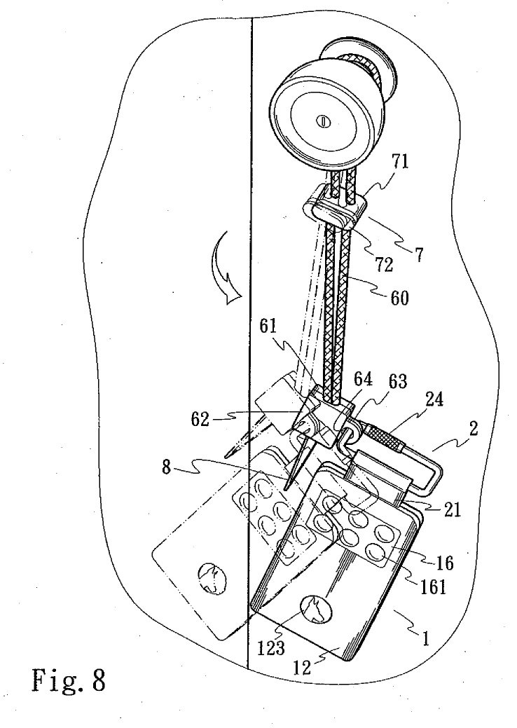

FIGS. 5 through 8 show a construction and operating status of a third preferred embodiment of the present invention. Other than the alarm unit 1 and the hook 2, a choke 6, a soft and flexible wire sling 60, a locating member 7, and an insertion elastic tongue 8 are further provided to the alarm. Wherein, the choke 6 includes a base 61 and an upper cover 62; one or a plurality of pair comprised of a narrow opening 611 and a notch 612 abutted to each other is disposed to one side of the base 61; and a raised portion 63 disposed with an eyelet 64 is laterally protrudes from one side of the choke 6 for the hook 2 to hook upon for connection. The insertion elastic tongue 8 is folded at its center to form a V-shape clip with one end further disposed with a reverse hooking portion 81 to be secured in the narrow opening 611 of the base 61 while the other end of the insertion elastic tongue 8 extends into the notch 612 of the base 61 to define a flexible movement limitation. The wire sling 60 has its both ends incorporated into the chock 6 to form a loop. The locating member 7 comprised of a holder 71 and a mobile elastic member 72 receives insertion of two ends of the wire sling 60. The holder 71 contains an accommodation space 711 with its opening disposed on top of the holder 712 to receive a lower portion 721 of the mobile elastic member 72. The holder 71 is disposed with a pair of through holes 712 penetrating through both wider sides of the locking member 61 and a pair of corresponding through holes 722 are provided penetrating through both wider sides of the mobile elastic member 72. Accordingly, both ends of the wire sling 60 respectively pass through their corresponding through holes 712, 722. An elastic member 73 is disposed between the holder 71 and the mobile elastic member 72 to hold against where between the holder 71 and the mobile elastic member 72 for the through hole 711 on the holder 71 and the through hole 722 on the mobile elastic member 72 to form a malposition.

In use, the wire sling 60 in a loop is hung upon on a raised portion of an object (e.g., a rose base of a tubular lock on a door) to be incorporated with the alarm; the mobile elastic member 72 is pressed to have its through holes 722 to be aligned to where the through hole 712 on the holder 71 is located for the locating member 7 to move up along both sides of the wire sling 60 before adjusting the size of the loop of the wire sling 60 depending on a diameter of the rose base of the tubular lock on the door. Upon properly adjusting the size of the loop, the mobile elastic member 72 is released to form a malposition between the through hole 722 on the mobile elastic member 72 and the through hole 712 on the holder 71 so to secure the locating member 7 to the wire sling 60. Finally, the insertion elastic tongue is inserted into a gap of two different structural components (e.g., a door panel 91 and a door frame 9) to complete a burglarproof status. The alarm unit 1 is activated. Once a position of either of both structural components sandwiching the insertion elastic member 8 (e.g., the door panel 91 is opened up), the insertion elastic member will drop off to cause the alarm unit 1 to tile and vibrate thus to generate audible alarm. Meanwhile the alarm unit 1 may be hung upon on a raised portion (e.g., a door handle) by means of the hook 2, the choke 6 and the wire sling 60 to avoid damage from direct fall onto the ground.

It is to be noted that the preferred embodiments disclosed in the specification and the accompanying drawings are not limiting the present invention; and that any construction, installation, or characteristics that is same or similar to that of the present invention should fall within the scope of the purposes and claims of the present invention.

I claim:

1. A multiple portable alarm to comprising an alarm unit to detect abnormal tiling or vibration to generate audible alarm; a hook incorporated to the alarm unit being related to a ring shape provided with an opening; a wider long side and a narrow short side being respectively disposed to both sides of an opening of the hook; a long screw sleeve being inserted to a free end of the long side; a terminal of the short side being engaged to the long screw sleeve; the opening of the hook being blocked out by the long screw sleeve; the hook being inserted to a connecting component; and the hook being secure to a preset location through the connecting component.

2. The multi-purpose portable alarm as claimed in claim 1, wherein the connecting components is related to a locking member, a through hole is laterally disposed on one end of a bolting portion; the bolting portion is externally threaded; and the hook locks in and connects to the through hole.

3. The multi-purpose portable alarm as claimed in claim 2, wherein the bolting portion of the locking member is screwed into a central screw hole disposed at a retainer; the retainer extends into a rectangular locking hole disposed on one edge of a Notebook, the retainer in the locking hole is deflected, and the retainer is outwardly packed and secured on the inner side of the locking hole.

4. The multi-purpose portable alarm as claimed in claim 3, wherein a raised portion is externally disposed to the retainer; and the raised portion when in packed status is secured in the locking hole to prevent the retainer from rotating.

5. The multi-purpose portable alarm as claimed in claim 1, wherein the connecting component includes a choke, a soft and flexible wire sling, and an insertion elastic tongue; the wire sling has its both ends incorporated into the choke chock to externally form a loop; the loop hooks upon a raised portion from an object to be incorporated, an eyelet is disposed to one side of the choke to engage the hook; one end of the insertion elastic member is fixed to the choke; and the other end of the insertion elastic member is inserted into a gap between two different types of structures.

6. The multi-purpose portable alarm as claimed in claim 5, wherein wire sling has its both ends passing through a locating member, the locating member is comprised of a holder and a mobile elastic member; the holder contains an accommodation space with its opening disposed on top of the holder to receive a lower portion of the mobile elastic member; the holder is disposed with a pair of through holes; a pair of corresponding through holes are provided on the mobile elastic member; both ends of the wire sling respectively pass through their corresponding through holes; an elastic member is disposed between the holder and the mobile elastic member to hold against where between the holder and the mobile elastic member; the through hole on the holder and the through hole on the mobile elastic member form a malposition to clamp and secure the wire sling.

7. The multi-purpose portable alarm as claimed in claim 5, wherein the choke includes a base and an upper cover; one or a plurality of pair comprised of a narrow opening and a notch abutted to each other is disposed to one side of the base; the insertion elastic tongue has one end further disposed with a reverse hooking portion to be secured in the narrow opening of the base; and the other end of the insertion elastic tongue extends into the notch of the base to define a flexible movement limitation.

8. The multi-purpose portable alarm as claimed in claim 6, wherein the choke includes a base and an upper cover; one or a plurality of pair comprised of a narrow opening and a notch abutted to each other is disposed to one side of the base; the insertion elastic tongue has one end further disposed with a reverse hooking portion to be secured in the narrow opening of the base; and the other end of the insertion elastic tongue extends into the notch of the base to define a flexible movement limitation.

9. The multi-purpose portable alarm as claimed in claim 5, wherein the insertion elastic tongue is folded into a V-shape piece.

10. The multi-purpose portable alarm as claimed in claim 6, wherein the insertion elastic tongue is folded into a V-shape piece.

11. The multi-purpose portable alarm as claimed in claim 7, wherein the insertion elastic tongue is folded into a V-shape piece.

12. The multi-purpose portable alarm as claimed in claim 8, wherein the insertion elastic tongue is folded into a V-shape piece.

13. The multi-purpose portable alarm as claimed in claim 1, wherein the free end of the short side of the hook is externally threaded, and the respective end of the screw sleeve is internally threaded.

14. The multi-purpose portable alarm as claimed in claim 2, wherein the free end of the short side of the hook is externally threaded, and the respective end of the screw sleeve is internally threaded.

15. The multi-purpose portable alarm as claimed in claim 3, wherein the free end of the short side of the hook is externally threaded, and the respective end of the screw sleeve is internally threaded.

16. The multi-purpose portable alarm as claimed in claim 4, wherein the free end of the short side of the hook is externally threaded, and the respective end of the screw sleeve is internally threaded.

17. The multi-purpose portable alarm as claimed in claim 5, wherein the free end of the short side of the hook is externally threaded, and the respective end of the screw sleeve is internally threaded.

18. The multi-purpose portable alarm as claimed in claim 6, wherein the free end of the short side of the hook is externally threaded, and the respective end of the screw sleeve is internally threaded.

19. The multi-purpose portable alarm as claimed in claim 7, wherein the free end of the short side of the hook is externally threaded, and the respective end of the screw sleeve is internally threaded.

20. The multi-purpose portable alarm as claimed in claim 8, wherein the free end of the short side of the hook is externally threaded, and the respective end of the screw sleeve is internally threaded.

21. The multi-purpose portable alarm as claimed in claim 9, wherein the free end of the short side of the hook is externally threaded, and the respective end of the screw sleeve is internally threaded.

22. The multi-purpose portable alarm as claimed in claim 10, wherein the free end of the short side of the hook is externally threaded, and the respective end of the screw sleeve is internally threaded.

23. The multi-purpose portable alarm as claimed in claim 11, wherein the free end of the short side of the hook is externally threaded, and the respective end of the screw sleeve is internally threaded.

24. The multi-purpose portable alarm as claimed in claim 12, wherein the free end of the short side of the hook is externally threaded, and the respective end of the screw sleeve is internally threaded.
